(19) United States
(12) Patent Application Publication
(10) Pub. No.: US 2026/0302653 A1
(43) Pub. Date: Oct. 1, 2026

(54) CONNECTION SYSTEM FOR CONNECTING TWO ELECTRICAL CONDUCTORS

(71) Applicant: Webasto Roof & Components SE, Stockdorf (DE)

(72) Inventor: Volker Böhringer, Stockdorf (DE)

(21) Appl. No.: 19/630,796

(22) Filed: Mar. 27, 2026

(30) Foreign Application Priority Data
Mar. 28, 2025 (DE) 102025112305.5

(51) Int. Cl. H01R 4/34; H01M 50/503

(52) U.S. Cl. CPC H01R 4/34; H01M 50/503

(57) ABSTRACT

A connection system for connecting a first conductor to a second conductor, where the connection system comprises: a connecting section which is designed to mechanically and electrically connect the first conductor and the second conductor to each other; a first protective device, comprising a first protective cap for receiving the first conductor in the region of the connecting section, and a first cover which is configured to be transferred from a protection state, in which the first conductor is covered on the connection side for connection to the second conductor, into a connected state, in which the first conductor is exposed for connection to the second conductor; a second protective device, comprising a second protective cap for receiving the second conductor in the region of the connecting section, and a second cover which is configured to be transferred from the protection state.

### CROSS-REFERENCE TO RELATED APPLICATION

This application claims priority to German Application No. DE 102025112305.5 filed on Mar. 28, 2025, which is incorporated herein by reference in its entirety for all purposes.

### TECHNICAL FIELD

The invention relates to a connection system for connecting a first electrical conductor to a second electrical conductor, for example in a high-voltage application.

### BACKGROUND

Interfaces of live components, which are connected releasably, for instance by means of a screw connection, can have touch protection to protect persons from direct contact with the live components. This is important and is often required by specific norms and standards to avoid accidents, electric shocks or other health risks that can arise from contact with the electrically charged components.

The live components can be, for example, busbars, or battery module connections, which can be provided for the construction of a vehicle battery for an electrically driven vehicle.

In the case of high-voltage systems (>60 V, e.g. 400 V or 800 V), compliance with touch protection (e.g. according to IPXXB) is relevant for occupational safety when installing the vehicle battery. It is often required that the touch protection is maintained both before and after the interface is connected.

Interfaces or terminals of electrical components with touch protection are found, for example, in DE 10 2014 017 081 A1, DE 10 2014 012 320 B3 and DE 10 2013 005 109 A1.

Conventional technical solutions often have a high complexity in the form of many individual parts requiring laborious pre-mounting. This leads to high costs and can also have an adverse effect on fail-safeness and reliability. In addition, screws and nuts overmoulded with plastic, which are significantly more expensive than conventional standard parts, are often required.

### SUMMARY

One object of the invention is to provide an improved connection system for connecting a first electrical conductor to a second electrical conductor, for example to provide a touch protection for current-conducting or voltage-conducting components in a structurally simple, fail-safe and reliable manner.

The object is achieved by a connection system having the features of claim 1. Advantageous developments follow from the subclaims, the following summary of the invention and the description of preferred exemplary embodiments.

The connection system is used to electrically connect a first (electrical) conductor to a second (electrical) conductor. The connection system is suitable, for example, for use in vehicle batteries for electrically driven vehicles, especially in the high-voltage range (>60 V, e.g. 400 V or 800 V).

The connection system comprises a connecting section which is configured to mechanically and electrically connect the first conductor and the second conductor to each other. This can be a releasable connection.

The connection system further comprises a first protective device comprising a first protective cap for receiving the first conductor in the region of the connecting section and a first cover, which can be transferred from a protection state, in which the first conductor is covered on the connection side for connection to the second conductor, into a connected state, in which the first conductor is exposed for connection to the second conductor.

The connection system analogously has a second protective device comprising a second protective cap for receiving the second conductor in the region of the connecting section and a second cover, which can be transferred from the protection state, in which the second conductor is covered on the connection side for connection to the first conductor, into the connected state, in which the second conductor is exposed for connection to the first conductor.

The first protective device and the second protective device can be brought into a connecting position for connecting the two conductors to each other, in which connecting position the two covers, for example, lie on top of each other. The exact relative position and location of the two protective devices in the connecting position can be ensured or assisted by a latching means, a positive fit, stop or the like.

The first cover and the second cover are connected to each other in the connecting position via a coupling mechanism in such a way that a transfer of the first cover from the protection state into the connected state (automatically or simultaneously) causes a transfer of the second cover from the protection state into the connected state.

By the two electrical conductors having individual touch protection by the associated protective devices and the covers interacting in the connecting position in such a way that a joint or simultaneous transition from the protection state into the connected state takes place, the connection system according to the disclosure realises complete touch protection, both before, during, and after the mechanical and electrical connection of the two conductors, i.e. both in the installed and in the uninstalled state.

Furthermore, the two conductors can be electrically connected to each other via only one contact surface, which results in a low contact resistance.

The connection system realises touch protection for the current-conducting or voltage-conducting components with a comparatively small number of individual parts. This not only reduces resources and costs, but also simplifies the pre-mounting of the components forming the connection system. The connection system is fail-safe and reliable.

The composition of the individual parts, comprising geometry, material, etc., is structurally comparatively simple, which results in a robust design and a low requirement for installation space.

The connecting section can comprise a screw for screwing the first conductor and the second conductor to each other. The screw extends, for example, through a corresponding screw opening of the first conductor and engages in the connected state into a corresponding internal thread of a screw opening of the second conductor, whereby the first conductor and the second conductor are electrically and mechanically connected to each other. The connection or screwing can only be carried out in the connected state of the connection system, since the corresponding sections of the first and second conductor in the protection state are covered by the corresponding covers of the protective devices.

The screw can have an internal profile in the screw head, for example a hexagon profile, in order to be able to screw the screw in and out by means of a corresponding tool, for example an insulated Allen key.

The screw can be preloaded or raised on the first conductor by means of a spring counter to the connecting direction, whereby the screw has a defined position even when not screwed in. This improves the mountability and reliability of the connection system.

The first protective cap can have a tool opening, through which a tool, for instance an Allen key, can be inserted into the first protective device for actuating the connecting section.

The tool opening can comprise at least one holding device and/or at least one holding clip for holding the screw in a pre-mounting position, such that simple assembly and connection of the two conductors can be achieved.

The first cover can be realised as a sliding cover, comprising a first protective cover which is mounted movably. Alternatively or additionally, the second cover can be realised as a sliding cover, comprising a second protective cover which is mounted movably. The design of the cover/covers as sliding cover/covers provides a mechanically simple and reliable solution for providing the touch protection in the installed and uninstalled state as well as for the joint establishing of the connected state.

Alternatively, the cover/covers can be based on a swivel principle, tilt principle or any other form of movement suitable to ensure a joint transition from the protection state into the connected state.

The first cover can comprise a first actuating section and/or a first actuating lever, via which the first protective cover is slidable from the protection state into the connected state. The operation can be performed manually by an operator here. The first protective cover with associated actuating section can have sliding wings, for example two sliding wings, which engage into corresponding rails of the first sliding frame.

Analogously, the second cover can have a second actuating section which, however, is slidable by the coupling mechanism from the protection state into the connected state. The coupling mechanism can be realised via a driving section which is arranged on the first actuating section or realised by the latter or formed as a section thereof, such that the transmission of force from the first cover to the second cover for the common transfer from the protection state into the connected state takes place directly and mechanically simply and reliably. The second protective cover with associated actuating section can have sliding wings, for example two sliding wings, which engage into corresponding rails of the second sliding frame.

The first protective device and the second protective device can be designed such that a transfer from the protection state into the connected state leads to fixing of the two protective devices to each other, whereby the release of the connecting section synergetically comprises a safeguard which prevents the protective devices from being separated from each other without effective touch protection.

For this purpose, the driving section can have the form of sliding wings and be configured to engage into the rails of the second sliding frame during the movement of the first actuating section from the protection state into the connecting state, whereby positively locking fixing of the two protective devices to each other takes place. In this case, the driving section of the first cover not only serves to actuate the second cover, but rather acts simultaneously/synergetically as a fastening mechanism for fixing the two protective devices to each other.

The fixing can be realised by a positively locking connection of the first protective device to the second protective device using the first cover.

The first cover can form a locking region, which can be brought into positively locking engagement with a complementary protrusion of the second cover of the second protective device for fixing the first protective device to the second protective device.

Therefore, the first cover and the second cover can have the coupling mechanism already explained above. Here, the coupling section in addition to the driving section preferably allows the second cover to be driven in both directions, whereby the two protective devices and the associated lines can be disconnected from each other again and can be reset into the protection state before the separation.

The coupling mechanism can comprise a pin on the first protective cover or the second protective cover and a pin receptacle on the other protective cover, wherein the pin can latch into the pin receptacle for coupling the two protective covers. In this way, the coupling mechanism can be implemented in a mechanically simple and reliable way. However, alternative mechanisms are possible, such as clamps, latches, stops and the like.

The first cover and/or second cover can comprise one or more latches for defining the protection state and/or connected state, for instance in order to prevent unintentional actuation of the covers, for example unintentional opening or cancelling of the touch protection. The latch/latches can be realised via a positively locking and/or non-positive connection, for example snap-in connections or the like.

The first conductor can be designed as a busbar or conductor rail, for example in a vehicle battery of an electrically driven vehicle. The second conductor can be designed as a terminal of a battery module in a vehicle battery, for example a high-voltage battery.

Further advantages and features of the present disclosure can be seen from the following description of preferred exemplary embodiments. The features described therein can be implemented on their own or in combination with one or more of the features described above, provided that the features do not contradict each other. The following description of preferred exemplary embodiments is made here with reference to the accompanying drawings.

### BRIEF DESCRIPTION OF THE DRAWINGS

Preferred further embodiments of the invention will be explained in greater detail by the following description of the figures, in which:

FIG. 1 shows a perspective view of a connection diagram with a first electrical conductor and a second electrical conductor, which are to be connected to each other via a connecting section,

FIG. 2 shows a perspective view of a connection system in a first embodiment with a first protective device and a second protective device,

FIG. 3 shows a perspective view of a first cover in the protection state according to the first embodiment,

FIG. 4 shows a perspective view of the first cover from FIG. 3 with the first protective cover taken off,

FIG. 5 shows the first cover of FIGS. 3 and 4 from a different perspective,

FIG. 6 shows a perspective view of the second protective device of the first embodiment with a second cover,

FIG. 7 shows a perspective view of the second cover of FIG. 6 with the second protective cover taken off,

FIG. 8 shows a perspective view of the first cover and second cover of the first embodiment in an assembled state,

FIG. 9 shows a perspective view of the first protective cover and second protective cover of the first embodiment with one variant of a coupling mechanism,

FIG. 10 shows a perspective view of the first protective cover and second protective cover with a coupling mechanism in a further variant,

FIG. 11 shows perspective illustrations of a section, in which the positions of the covers are defined via latches,

FIG. 12 shows a perspective view of a connection system in a second embodiment, wherein the connection system is shown here in a completely closed configuration,

FIG. 13 shows a perspective view of the connection system from FIG. 12, wherein the first protective cap is removed,

FIG. 14 shows a schematic illustration of the first and second protective cover of the connection system from FIGS. 12 and 13,

FIG. 15 shows a schematic representation of the process of unlocking a locking clip by means of an unlocking tab in a first position, in which the unlocking process is not yet completed,

FIG. 16 shows a schematic illustration of the unlocking process, wherein the unlocking tab has now fully unlocked the locking clip,

FIG. 17 shows a schematic illustration of the locking of the second protective cover to the second protective cap,

FIG. 18 shows a schematic illustration of a connection system in yet another embodiment, wherein the connection system is completely closed,

FIG. 19 shows a schematic illustration of the second protective cap and the movable second protective cover of the connection system of FIG. 18,

FIG. 20 shows a further schematic illustration of the second protective cap from FIG. 19,

FIG. 21 shows a further schematic illustration of the second protective cap from FIG. 19 and FIG. 20,

FIG. 22 shows a schematic illustration of the second protective cover of this exemplary embodiment,

FIG. 23 shows a schematic illustration of the first protective cover of this exemplary embodiment,

FIG. 24 shows a schematic illustration of the interaction of the first protective cover and the second protective cover of this exemplary embodiment,

FIG. 25 shows a schematic illustration of the first cover with the second protective cap of this exemplary embodiment mounted therein,

FIG. 26 shows a schematic sectional view through the design of FIG. 25,

FIG. 27 shows a schematic illustration of a battery module with a terminal to be contacted,

FIG. 28 shows a schematic illustration of a battery module contacted via the connection system,

FIG. 29 shows a schematic inner view of a protective cap, in which a holding device for holding a screw in a mounting position is provided around a tool opening, and

FIG. 30 shows a schematic sectional illustration of a protective cap, in which holding clips are provided for holding a screw in a mounting position.

### DETAILED DESCRIPTION

Preferred exemplary embodiments are described below with reference to the figures. Here, identical, similar or functionally identical elements in the figures are provided with identical reference signs, and a repeated description of these elements is in some cases dispensed with in order to avoid redundancies.

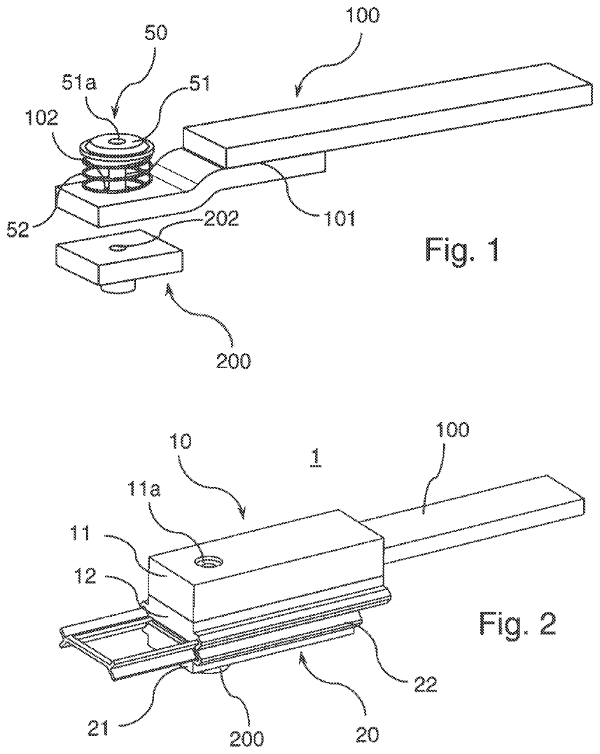

FIG. 1 is a perspective view of a connection diagram with a first electrical conductor 100 and a second electrical conductor 200, which can be releasably connected to each other via a connecting section 50. The connection diagram is suitable, for example, for use in the high-voltage range (>60 V, e.g. 400 V or 800 V).

Here, the first conductor 100 can be designed as a busbar, conductor rail or the like, possibly with a welding adapter 101. The second conductor 200 can be designed as a terminal, for example as a terminal of a high-voltage battery.

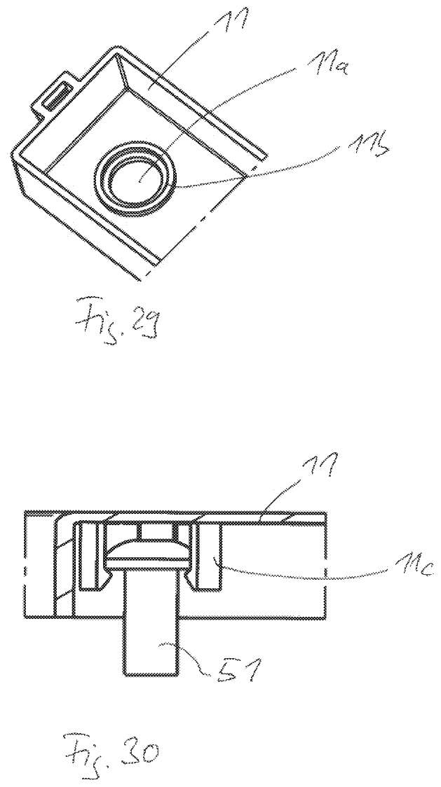

A schematic illustration of a battery module 30 of a high-voltage battery with a terminal 3 is shown schematically and exemplarily in FIGS. 27 and 28 and described below.

The connecting section 50 is configured in the present exemplary embodiment as a screw connection, comprising a screw 51 which is arranged in the unconnected state on the first conductor 100. The screw connection can further comprise a spring 52, which lifts the screw 51 in the unconnected state, i.e. preloads it counter to the connection direction. The screw 51 extends through a screw opening 102 of the first conductor 100 and engages in the connected state into a corresponding internal thread of a screw opening 202 of the second conductor 200, whereby the first conductor 100 and the second conductor 200 are electrically and mechanically connected to each other. The screw 51 can have an inner profile 51a in the screw head, for example a hexagonal profile, in order to be able to screw the screw 51 in and out by means of a corresponding tool, for example an insulated Allen key.

FIGS. 29 and 30 show alternatives to the embodiment of the screw 51 with a spring, wherein, in these alternatives, the screw 51 is held in a pre-mounting position by a ring magnet (FIG. 29) or by clips 11c. These two alternatives are described further below in relation to the figures mentioned.

FIG. 2 is a perspective view of a connection system 1 in a first embodiment, which serves for the safe connection of the first conductor 100 to the second conductor 200 and, for this purpose, is equipped with comprehensive touch protection. The two electrical conductors 100, 200 can be conceptually part of the connection system 1 or can be understood separately from it.

The connection system 1 comprises a first protective device 10, which is assigned to the first electrical conductor 100, and a second protective device 20, which is assigned to the second electrical conductor 200. The two protective devices 10, 20 are generally made of a non-conductive material, for example plastic. The protective devices 10, 20, in a state in which they are assembled or stacked on one another or plugged onto one another, together surround the connecting section 50 and the first and second conductors 100, 200 at least in the region of the connecting section 50 in such a way that the connecting section 50 is protected or shielded from accidental contact with an operator before, during and after the connection of the two conductors 100, 200.

In the present exemplary embodiment, the first protective device 10 is constructed in multiple parts, comprising a first protective cap 11 and a first cover 12. The first protective cap 11 has a tool opening 11a, through which a tool for actuating the connecting section 50, for example an Allen key, is insertable. The tool opening 11a is dimensioned and geometrically shaped such that accidental contact of the connecting section 50, for example the screw 51, from outside the first protective cap 11 is prevented.

The first cover 12 closes the first protective cap 11 on the underside. The first cover 12 can be transferred from a protection state, in which the first conductor 100 is substantially completely surrounded and thus protected by the first protective device 10 in the region of the connecting section 50, into a connecting state, in which the connecting section 50 is exposed for connecting the first conductor 100 to the second conductor 200.

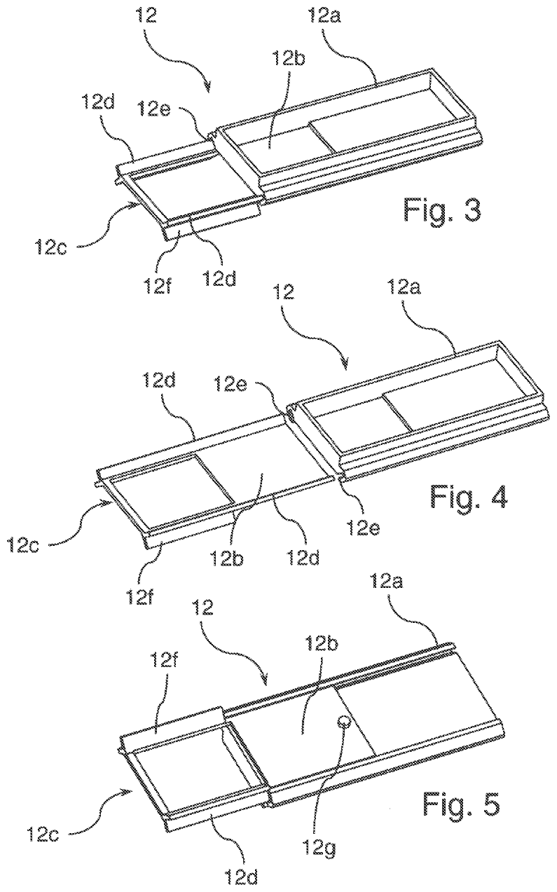

FIG. 3 shows one exemplary embodiment of the first cover 12 in the protection state. The first cover 12 is realised in this case as a sliding cover, comprising a first sliding frame 12a, in which a first protective cover 12b is mounted movably. The first sliding frame 12a is connected or connectable to the first protective cap 11 on its underside. Alternatively, the first sliding frame 12a and the first protective cap 11 can be of one-piece design.

The first protective cover 12b comprises a first actuating section 12c, via which the first protective cover 12b can be transferred or moved from the protection state into the connected state. The first protective cover 12b with associated actuating section 12c has a special lateral geometry (here, inclined sliding wings 12d) which engage into corresponding rails 12e of the sliding frame 12a (see also FIG. 4). FIG. 5 shows the first cover 12 from a different perspective.

The actuating section 12c can be actuated by an operator in order to transfer the connection system 1 from the protection state into the connected state as soon as the first protective device 10 is firmly connected to the second protective device 20. As soon as the first protective device 10 is firmly connected to the second protective device 20, there is no longer a risk of contact of the live conductors 100, 200 for the operator, since the conductors 100, 200 are then completely surrounded in the region of the connecting section 50 by the connection system 1.

The first actuating section 12c further comprises a driving section 12f, the nature and function of which is described below in conjunction with the second protective device 20.

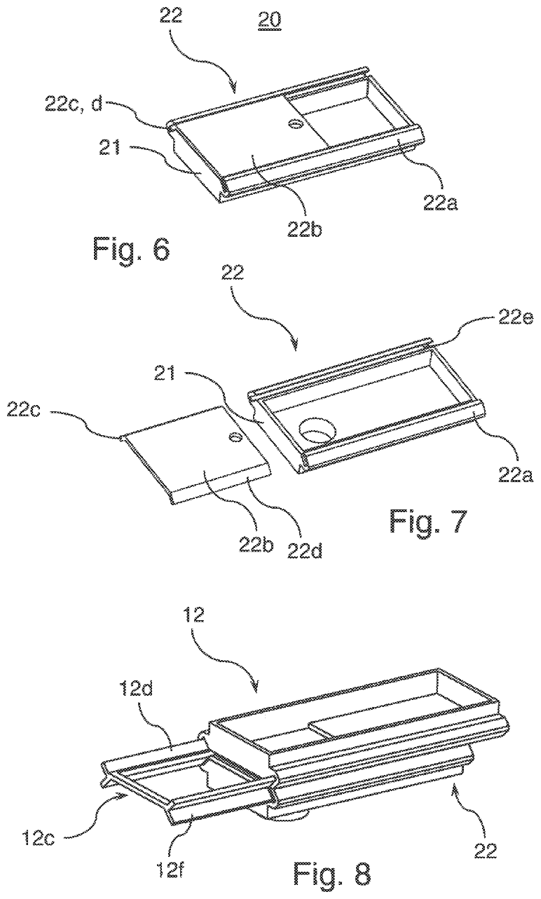

FIG. 6 shows the second protective device 20 according to one exemplary embodiment. The second protective device 20 comprises a second protective cap 21 and a second cover 22. The second cover 22 closes the second protective cap 21 of the second protective device 21 on the top. The second cover 22 can also be transferred from a protection state, in which the second conductor 200 is substantially completely surrounded by the second protective device 20 and thus protected in the region of the connecting section 50, into a connected state, in which the connecting section 50 is exposed for connecting the first conductor 100 to the second conductor 200.

FIG. 6 shows one exemplary embodiment of the second cover 22 in the protection state. The second cover 22 is also realised in this case as a sliding cover, comprising a second sliding frame 22a, in which a second protective cover 22b is mounted movably. The second sliding frame 22a and the second protective cap 21 of the second protective device 20 are constructed in one piece in the present exemplary embodiment.

The second protective cover 22b comprises a second actuating section 22c, via which the second protective cover 22b can be transferred or moved from the protection state into the connected state. The second protective cover 22b with associated actuating section 22c has a special lateral geometry (here, inclined sliding wings 22d) which engage into corresponding rails 22e of the sliding frame 22a (see also FIG. 7).

The second actuating section 22c is actuated by contact with the driving section 12f of the first actuating section 12c of the first cover 12. In other words, by moving the first actuating section 12c from the protection state into the connected state, the first actuating section 12c comes into contact with the second actuating section 22c, whereby both protective covers 12b, 22b are simultaneously transferred into the connected state. The driving section 12f preferably has the shape of sliding wings, which correspond to the shape of the sliding wings 22d of the second protective cover.

FIG. 8 shows the first cover 12 and the second cover 22 in an assembled or stacked state. Both covers 12, 22 are in the protection state.

The two covers 12, 22 provide individual touch protection for the first conductor 100 and the second conductor 200 in the unassembled or unconnected state. For assembly, the first protective device 10 and the second protective device 20 (with closed covers 12, 22) are placed on top of each other or plugged on top of each other.

By actuating or pushing in the first actuating section 12c, the covers 12, 22 are moved into the connected state, wherein the first actuating section 12c drives the second actuating section 22c via the driving section 12f. After the connecting section 50 is exposed in this way, the screw 51 can be tightened via the tool opening 11a for the mechanical and electrical connection of the two conductors 100, 200.

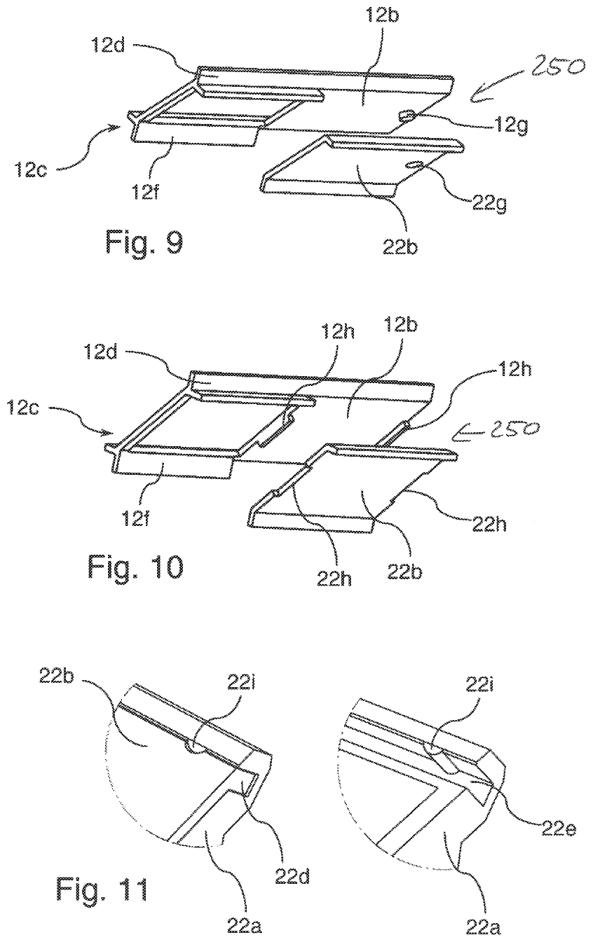

When mounting the upper or first protective device 10 on the lower or second protective device 20, the two covers 12, 22 lie on top of each other. By means of a pin 12g or the like, in addition to the contact of the two actuating devices 12c, 22c, a connection can be established, which makes it possible, when moving the first protective cover 12b, to drive the second protective cover 22b in both directions (see also FIG. 9). For this purpose, the pin 12g latches into a corresponding pin receptacle 22g of the second protective cover 22b.

The pin 12g and the pin receptacle 22g realise a coupling mechanism 250. An alternative coupling mechanism 250, comprising one or more webs 12h on the first protective cover 12b, which engage into corresponding recesses 22h on the second protective cover 22b, is shown in FIG. 10.

At the same time, the two protective devices 10, 20 are firmly connected to each other during the movement by the special lateral geometry of the first cover 12 (wing/rail system). Here, the driving section 12f of the first cover 12 moves into the rails 22e of the second cover 22, whereby the driving section 12f fixes the two protective devices 10, 20 to each other in the connected state.

Thus, fixing of the two protective devices 10, 20 takes place at least in the region, in which, due to the undercut receiving of the sliding wings 12d and the driving sections 12f of the first protective cover 12b in the respective rails 12e and 22e of the first cover 12 and the second cover 22, a positively locking connection is established. The sliding wings 12d and driving sections 12f formed in one piece with the first protective cover 12b act here as a fastening means, which connects the first and the second protective device 10, 20 to each other in a positively locking manner.

Disassembly is carried out in reverse order. When removing the first conductor 100, for example, both protective devices 10, 20 are then closed by the associated covers 12, 22.

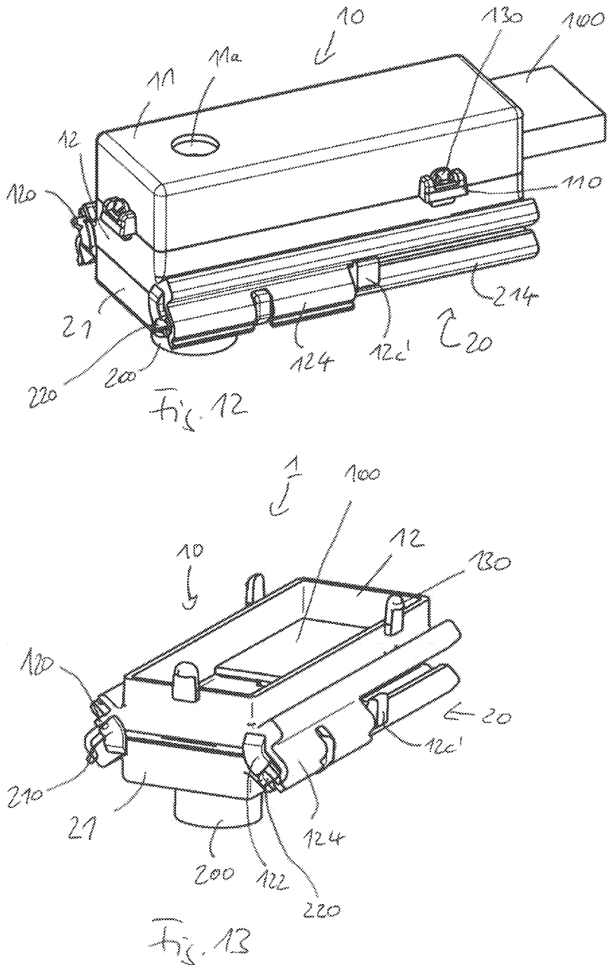

The positions of covers 12, 22 “open” vs. “closed” or “connected state” vs. “protection state” can be defined via latches 22i (see FIG. 11). The latches 22i are designed here in such a way that unintentional opening is prevented.

In the present exemplary embodiment, the closure geometry of the covers 12, 22 lies within the two protective devices 10, 20 or their protective caps 11, 21. Alternatively, it is possible to hold the two protective caps 11, 21 together from the outside by means of a surrounding frame.

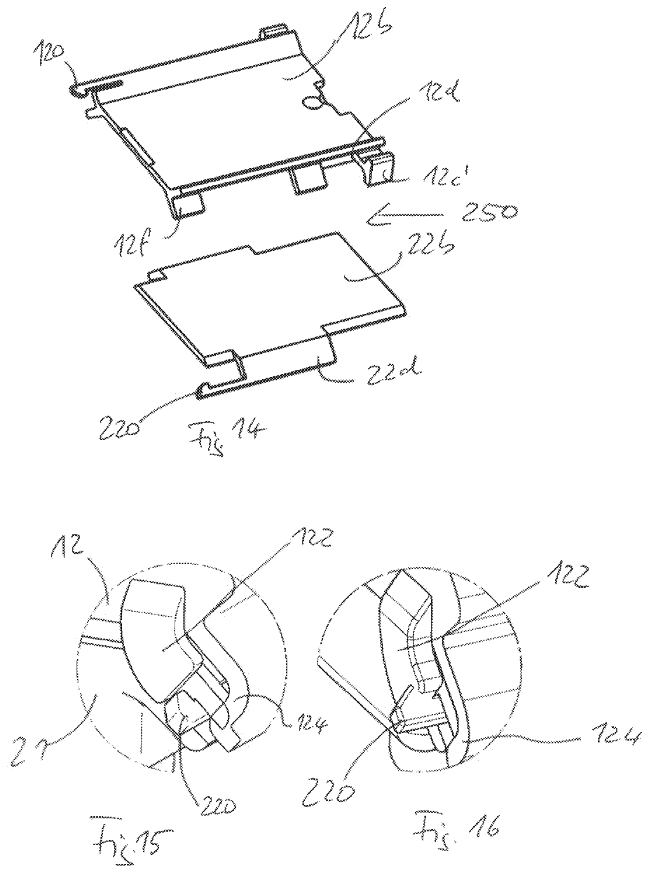

In FIG. 12, a perspective view of a connection system 1 is shown in a further exemplary embodiment, wherein this exemplary embodiment is oriented closely to the exemplary embodiments shown in the preceding figures. In the connection system 1 shown, a first electrical conductor 100 is once again connected to a second electrical conductor 200, wherein a first protective device 10 and a second protective device 20 are present, which structurally form the connection system 1 in the same manner as shown in the previous exemplary embodiments.

The first protective device 10 has a first protective cap 11 and a first cover 12 arranged underneath. The first cover 12 of the first protective device 10 is provided directly adjacent to a second protective cap 21 of the second protective device 20 in the connected state shown in FIG. 12, in which the first protective device 10 is connected to the second protective device 20.

The first protective cap 11 is connected in a clipped manner to the first cover 12 via protective cap locking clips 130 on protective cap locking receptacles 110 complementary with respect to them on the first protective cap 11.

FIG. 13 shows a schematic perspective illustration of the first protective device 10 and the second protective device 20, in which figure the first protective cap 11 is omitted, such that a view into the first cover 12 is made possible, in which the first conductor 100 can also be seen highly schematically.

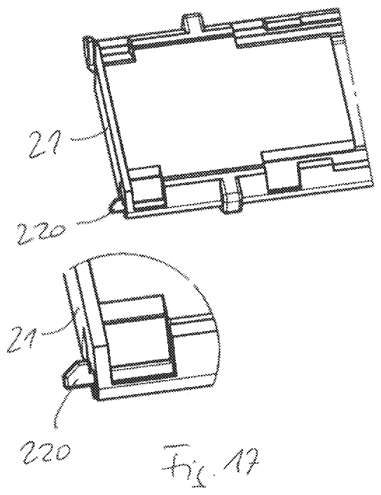

FIG. 14 shows a first protective cover 12b, which initially corresponds structurally and functionally to the protective cover 12b from the previous embodiments. However, this first protective cover 12b does not comprise the first actuating section 12c shown from the preceding embodiments. Also shown is a second protective cover 22b, which is connected movably to the second protective cap 21.

The first protective cover 12b and the second protective cover 22b interact as known from the previous embodiments, are connected via a coupling mechanism 250 described below, and can, for example, be moved together with each other.

Instead of the first actuating section 12c from the preceding embodiments, a first actuating lever 12c′ is shown, which can also be seen clearly in FIGS. 12 and 13. By means of the first actuating lever 12c′, the first protective cover 12b and the second protective cover 22b can be transferred or moved together from the protection state into the connected state. This movement can be carried out when the first protective device 10 and the second protective device 20 are connected to each other and the first protective cover 12b and the second protective cover 22b are coupled via the coupling mechanism 250.

The sliding wing 12d of the first protective cover 12b also serves in this embodiment to be received in a corresponding rail 12e of the first cover 12, in order to enable a targeted movement capability of the first protective cover 12b from the protection state into the connected state in this way.

The second protective cover 22b also has a sliding wing 22d, which is guided in a corresponding rail 22e of the second protective cap 21. The first protective cover 12b and the second protective cover 22b together form the two sliding vanes 12d, 22d when they are placed on top of each other. Here, a driving section 12f is formed in the first protective cover 12b, which driving section is arranged, in the assembled state, in the extension of the sliding wing 22d of the second protective cover 22b. In other words, the driving sections 12f engage around sections of the sliding wing 22d such that driving of the first protective cover 12b and the second protective cover 22b is achieved. The first sliding wing 12d is guided in the rail 12e of the first cover 12 here, whereas the second sliding wing 22d, which also comprises the driving sections 12f of the first protective cover 12b, is guided in the rail 22e. The coupling mechanism 250 is formed in this way, which leads to the fact that both protective covers 12b, 22b can be moved together with each other.

In this way, it is ensured that the first protective cover 12b and the second protective cover 22b can be moved together along the two rails 12e, 22e.

By the omission of the first actuating section 12c and its replacement by the first actuating lever 12c′, compared to the embodiments of FIGS. 3 to 11, a more compact overall dimension of the connection system 1 can be achieved, which does not protrude significantly beyond the extent or the footprint of the second conductor 200, for example in the protection state.

In the protection state, both the first protective cover 12b and the second protective cover 22b are locked in the respective protection position, in order to prevent accidental or manipulative violation of the protection state. To this end, a first locking clip 120 is provided on the first protective cover 12b, which first locking clip engages in the protective position into the first cover 12. Due to the locking of the first locking clip 120, the first protective cover 12b cannot be moved along the rail 12e of the cover 12 as long as the first locking clip 120 is in engagement with the first cover 12. This ensures that the protective cover 12b is not unintentionally transferred into the connected state, i.e. the open state. In this way, reliable behaviour of the connection system 1 can be ensured.

This locking between the first protective cover 12b and the cover 12 is maintained as long as the first locking clip 120 is not pushed open by an unlocking tab 210 of the second protective cap 21. This pushing open of the first locking clip 120 occurs when the first cover 12 is connected to the second protective cap 21 and these two housing parts are locked to each other.

The unlocking tab 210 is formed in such a way that, when the first cover 12 is joined together with the second protective cap 21, the unlocking tab 210 acts on the first locking clip 120 such that, when the first cover 12 is fully locked to the second protective cap 21, the first locking clip 120 is pushed out of engagement with the first cover 12.

Likewise, the second cover 22 has a second locking clip 220, which engages with the second protective cap 21, as long as an unlocking tab 122 does not move the second locking clip 220 from its locking with the second protective cap 21. This process of unlocking is shown schematically in FIGS. 15 and 16, wherein the unlocking tab 122 is shown in FIG. 15 adjacent to the second locking clip 220, since the housings of the second protective cap 21 and the first cover 12 are not yet fully latched to each other.

FIG. 16 then shows schematically how the unlocking tab 122 pushes the second locking clip 220 out of its latching with the second protective cap 21 in order to achieve in this way a movement capability of the second protective cover 20b.

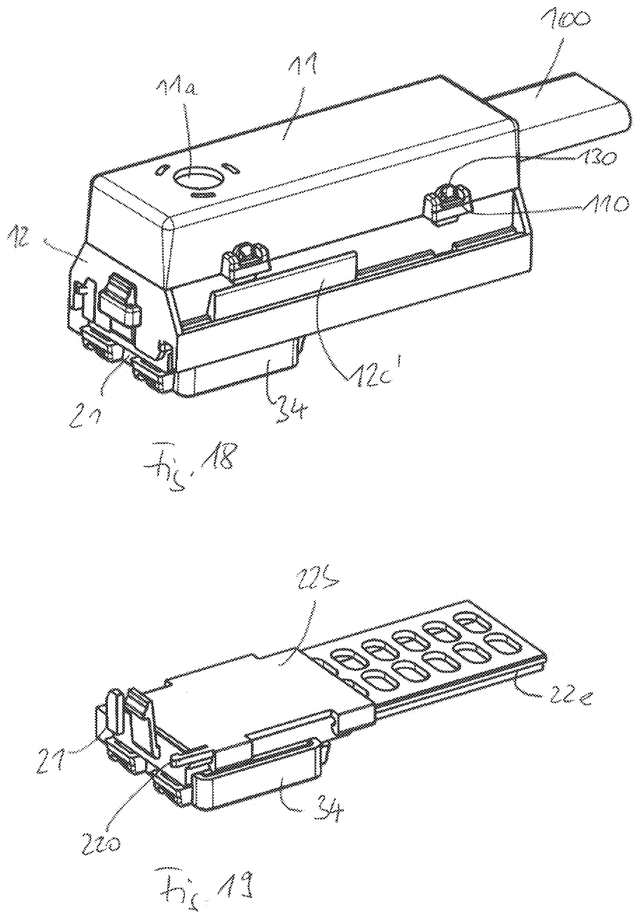

FIG. 17 shows the second protective cap 21 in a view from above, wherein the second protective cover 22b is inserted such that the second locking clip 220 is locked to the second protective cap 21, as can be seen particularly clearly in the enlarged magnified view.

In the preceding exemplary embodiment of FIGS. 3 to 11, the connection between the first cover 12 and the second protective cap 21 had been established substantially by virtue of the fact that the first actuating section 12c with its upwardly directed sliding wing 12d and the downwardly directed driving section 12f or the downwardly directed sliding wing 22d with its guide in the respective rails 12e and 22e have led to a connection of the second cover 22 to the first cover 12 having been achieved via the respective undercuts. In other words, the first protective device 10 and the second protective device 20 are connected to each other in a positively locking manner via the undercuts of the sliding wings 12d and driving sections 12f.

In the exemplary embodiment shown in FIGS. 12 to 17, in contrast, the connection of the first cover 12 to the second protective cap 21 and thus to the second cover 22 is achieved firstly by providing a clip-shaped locking region 124, which engages over a complementarily designed projection 214. In other words, the first cover 12 is clipped in on the second protective cap 21.

As can be seen in FIGS. 12 and 13, clipping the first cover 12 onto the second protective cap 21 can in this manner achieve that the locking region 124 engages over the projection 214, complementary to it, in order to achieve in this way locking and fixed fastening of the first cover 12 to the second protective cap 21 and thus of the first protective device 10 to the second protective device 20.

This can also be seen schematically in FIGS. 15 and 16, in which, in addition to the interaction of the unlocking tab 122 with the second locking clip 220, it can also be seen how the locking region 124 is guided over the protrusion 214, complementary to it, in order then to be fully connected in FIG. 16.

At the same time, however, a positively locking connection of the first protective device 10 to the second protective device 20 is achieved in the region, in which the first protective cover 12b has been pushed with its sliding wings 12d and driving sections 12f in the respective rails 12e, 22e. Here, the first protective cover 12b with its integrally formed sliding wings 12d and driving sections 12f acts again as a fastening means which, via the rails 12e, 22e, establishes a positively locking connection between the first protective device 10 and the second protective device 20.

FIG. 18 shows a connection system 1 in yet another exemplary embodiment. The connection system 1, as shown in FIG. 18, once again comprises a first protective cap 11, which is connected to a first cover 12 via protective cap locking clips 130, which engage into protective cap locking receptacles 110. The second protective cap 21 and the second cover 22 are together formed as a single component in the present case.

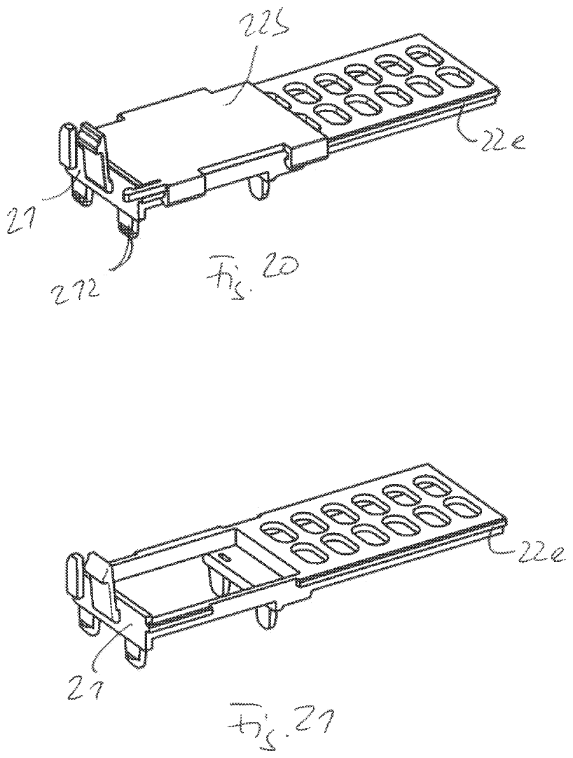

The second protective cap 21 is shown once again isolated in FIG. 19, wherein the protective cap 21 is clipped here onto a terminal 3, wherein the terminal 3 has a terminal housing 34, which encloses the second conductor 200. This is later shown again in FIGS. 27 and 28, in which the connection system 1 is shown together with a battery module 30.

FIG. 19 shows the second protective cap 21 in combination with a movable second protective cover 22b, which is pushed onto the second protective cap 21 in the embodiment shown in FIG. 19 in such a way that it is in principle movable. The second protective cap 21 also forms a rail 22e, on which the second protective cover 22b is movable from the protection state into the connected state. FIG. 19 shows the second protective cover 22b in a protection state, in which an intervention of a user on the terminal 3 arranged under the second protective cover 22b or the second conductor 200 is prevented.

The second protective cover 22b has a second locking clip 220, by means of which locking on the housing of the second protective cap 21 is made possible, such that the second protective cover 22b cannot be moved and thus cannot be moved from the protection state into the connected state for as long as the second locking clip 220 is in engagement with the second protective cap 21.

FIG. 20 once again shows the second protective cap 21 without its direct connection to the terminal 3, wherein it can be seen that downwardly directed clips 212 are provided, which are provided for connecting the second protective cap 21 to the terminal housing 34 of the terminal 3. The configuration provided in FIG. 19 is formed accordingly such that the second protective cap 21 is clipped via the clips 212 to the terminal housing 34 of the terminal 3.

Furthermore, the second protective cover 22b is clipped to the rails 22e of the second protective cap 21.

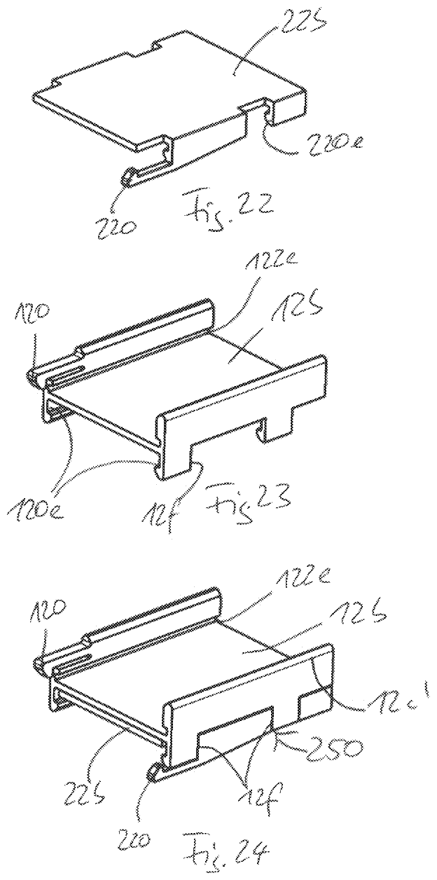

In FIG. 21, the second protective cap 21 can be seen without clipped components.

In FIG. 23, the first protective cover 12b can be seen, which can be mounted on the second protective cover 22b (also shown in isolation in FIG. 22). The second locking clip 220 is formed here in FIG. 22 in an alternative configuration to the locking clip 220 in FIG. 20. The first protective cover 12b has downwardly directed rail receptacles 120e, which are provided for engagement into the rails 22e of the second protective cap 21. These rail receptacles 120e of the first protective cover 12b, which are directed downwards, together with the rail receptacles 220e of the second protective cover 22b form a substantially continuous rail receptacle, in which the rail 22e of the second protective cap 21 can be guided, when the second protective cover 22b and the first protective cover 12b are moved from the protection state into the connected state.

In other words, the rail receptacles 120e of the first protective cover 12b and the rail receptacles 220e of the second protective cover 22b together engage around the rail 22e of the second protective cap 21 in the connected state, such that this region, in which the rail 22e of the second protective cap 21 is present, is engaged around jointly by the rail receptacles 120e and 220e. In this way, a secure positively locking connection of the first protective device 10 and the second protective device 20 can be achieved,

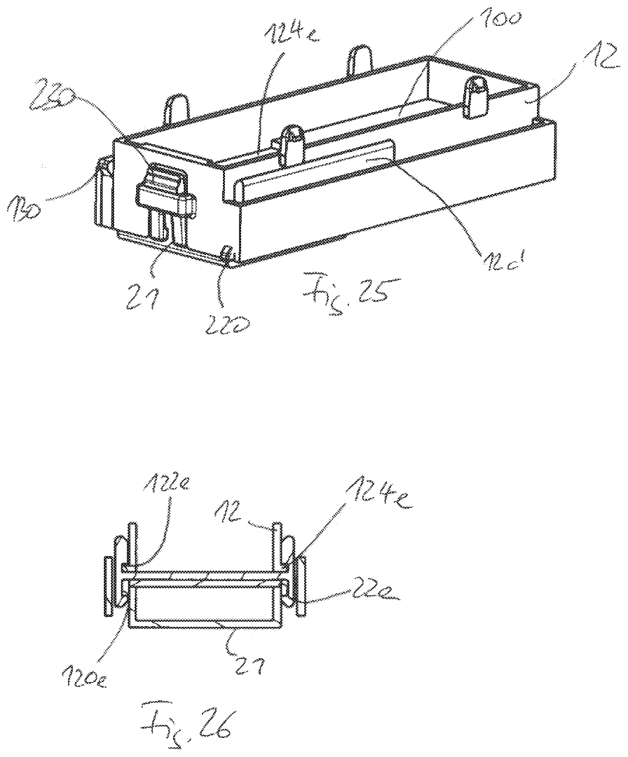

It can be seen in FIG. 24 how the interaction of the first protective cover 12b and the second protective cover 22b is achieved in that the rail sections 12e, 22e are designed such that they fit into each other or form a key/lock constellation here. In this way, the first protective cover 12b and the second protective cover 22b are also firmly connected to each other in the movement direction along the rail 22e and thus form the coupling mechanism 250.

Here, a side wall of the first protective cover 12b is designed in the form of a first fastening lever 12c′, which can also be seen in FIG. 18, and on which the connection system 1 can be transferred from the protection state into the connected state.

FIG. 25 shows the first cover 12 in an open position, wherein the second protective cap 21 is clipped in from below, and wherein at the same time the first protective cover 12b and the second protective cover 22b, as shown in FIG. 19, are also mounted. The connection of the second protective cap 21 to the first cover 12 is achieved at the front end, at which the connecting section 50 is located, via a clip connection 230.

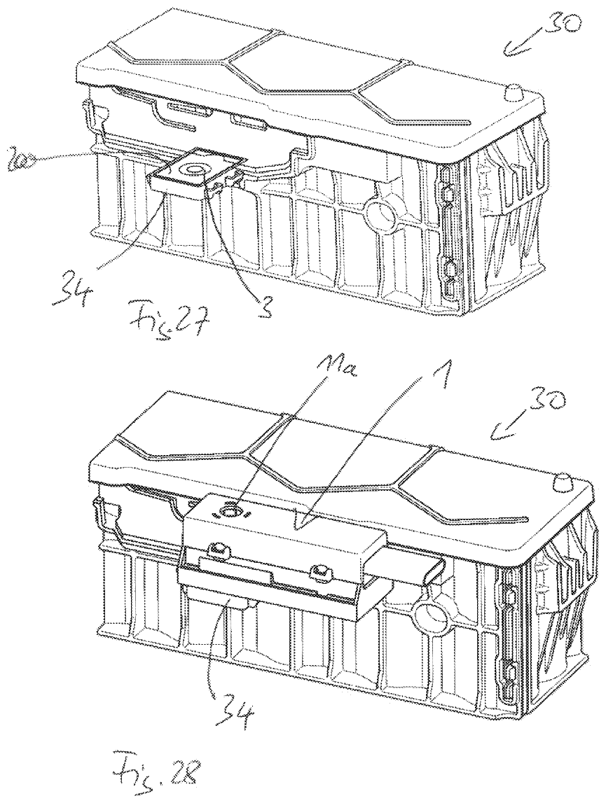

It can be seen in FIG. 26 that the first protective cover 12b is designed in such a way that, in addition to the rail sections 120e which extend downwards, it also comprises rail sections 122e, wherein the upwardly extending rail sections 122e are in engagement with a side wall of the first cover 12 or a rail section of the side wall 12, when the first protective cover 12 is moved into the mounting position, that is to say into a position, in which the rail 22e can be seen in FIG. 19.

In other words, a connection of the second protective cap 21 to the first cover 12 is made via the clip connection 230 in the front region, in which the connection between the first conductor and the second conductor is established, and a connection of the second protective cap 21 to the first cover 12 is made via a positively locking engagement of the rail receptacles 120e, 122b with corresponding rail regions 22e, 124e of the second protective cap 21 and the first cover 12 in the rear region, in which the rail 22e can be seen in FIG. 19.

FIG. 27 schematically shows a battery module 30, in which battery cells are provided in an arrangement and configuration not further discussed here. However, the battery cells received in the battery module 30 are contacted outwardly via a second conductor 200, wherein the second conductor 200 forms a terminal 3 to be contacted, which is received in a terminal housing 34. The terminal housing 34 also comprises, inter alia, clip receptacles 32, which can be connected to the downwardly directed clips 212 (shown, for example, in FIG. 20) of the second protective cap 21.

FIG. 28 accordingly shows an arrangement, in which the battery module 30 is contacted with the connection system 1, wherein the conductor 100 is connected to the conductor 200 via the connection system 1.

FIG. 29 shows the first protective cap 11 in a schematic illustration from the inside. Here, the tool opening 11a is shown, which is surrounded by a holding device 11b for a corresponding screw or a corresponding bolt.

A ring magnet can be inserted into the holding device 11b, by means of which ring magnet the screw is held in a pre-mounting position before it is screwed in by means of an appropriate tool. In the event of service, a screw can thus also be moved out of the mounting position again and be held in a raised position by the ring magnet, such that pushing of the first protective cover 12b and the second protective cover 22b into the protection state is made possible, such that a disconnection of the conductors 100, 200 from each other is made possible.

In a variant shown in FIG. 30, the first protective cap 11 is provided with clips 11c around the tool opening 11a, wherein the corresponding screw 51 is held in a pre-mounting position in the clips 11c. The screw 51 can then also be pulled back into these clips 11c again, if a disconnection of the conductors 100, 200 is required in the event of service.

The connection system 1 described herein implements complete touch protection in the installed and uninstalled condition. At the same time, the electrical connection of the two conductors 100, 200 takes place via only one contact surface, which results in a low contact resistance.

The connection system 1 implements the touch protection of the current-conducting or voltage-conducting components with a comparatively small number of individual parts. This not only leads to a reduction in resources and costs, but also simplifies the pre-mounting of the components forming the connection system 1. The connection system 1 is fail-safe and reliable.

The composition of the individual parts, comprising geometry, material, etc., is structurally comparatively simple, which results in a robust design and a low requirement for installation space.

Insofar as applicable, all individual features set forth in the exemplary embodiments can be combined with one another and/or interchanged without departing from the scope of the disclosure.

### LIST OF REFERENCE SIGNS

1 Connection system
10 First protective device
11 First protective cap
11a Tool opening
11b Holding device
11c Holding clip
12 First cover
12a First sliding frame
12b First protective cover
12c First actuating section
12c′ First actuating lever
12d Sliding wing
12e Rail
12f Driving section
12g Pin
12h Web
110 Protective cap locking receptacle
120 First locking clip
120e Rail section
122 Unlocking tab
122e Rail receptacle
124 Locking region
124e Rail region
130 Protective cap locking clip
20 Second protective device
21 Second protective cap
22 Second cover
22a Second sliding frame
22b Second protective cover
22c Second actuating section
22d Sliding wing
22e Rail
22g Pin receptacle
22h Recess
22i Latch
210 Unlocking tab
212 Clips for terminal
214 Complementary projection
220 Second locking clip
220e Rail section
230 Clip connection
250 Coupling mechanism
3 Terminal housing
30 Battery module
32 Clip receptacle
34 Terminal housing
50 Connecting section
51 Screw
51a Inner profile
52 Spring
100 First conductor
101 Welding adapter
102 Screw opening
200 Second conductor
202 Screw opening

1. A connection system for connecting a first conductor to a second conductor, wherein the connection system comprises:
a connecting section which is designed to mechanically and electrically connect the first conductor and the second conductor to each other;
a first protective device, comprising a first protective cap for receiving the first conductor in the region of the connecting section, and a first cover which is configured to be transferred from a protection state, in which the first conductor is covered on the connection side for connection to the second conductor, into a connected state, in which the first conductor is exposed for connection to the second conductor;
a second protective device, comprising a second protective cap for receiving the second conductor in the region of the connecting section, and a second cover which is configured to be transferred from the protection state, in which the second conductor is covered on the connection side for connection to the first conductor, into the connected state, in which the second conductor is exposed for connection to the first conductor;
wherein the first protective device and the second protective device are configured to be brought into a connecting position for connecting the two conductors to each other, and wherein the first cover and the second cover are connected to each other in the connecting position via a coupling mechanism such that a transfer of the first cover from the protection state into the connected state causes a transfer of the second cover from the protection state into the connected state.

2. The connection system according to claim 1, wherein the connecting section comprises a screw for screwing the first conductor and the second conductor to each other, wherein the screw is preloaded counter to the connection direction by means of a spring on the first conductor.

3. The connection system according to claim 1, wherein the first protective cap has a tool opening, through which a tool for actuating the connecting section is insertable, wherein the tool opening comprises at least one of: at least one holding device and at least one holding clip for holding a screw in a pre-mounting position.

4. The connection system according to claim 1, wherein at least one of: the first cover is a sliding cover, comprising a first protective cover, which is mounted movably; and the second cover is realised as a sliding cover, comprising a second protective cover, which is mounted movably.

5. The connection system according to claim 4, wherein the first cover has at least one of: a first actuating section and a first actuating lever, via which the first protective cover is slidable from the protection state into the connected state, wherein the first protective cover has sliding wings, which engage into corresponding rails of the first cover.

6. The connection system according to claim 5, wherein the second cover has a second actuating section, which is slidable from the protection state into the connected state by the coupling mechanism, wherein the second protective cover has sliding wings, which engage into corresponding rails of the second protective device.

7. The connection system according to claim 1, wherein the first protective device and the second protective device are designed such that, in the connecting position of the two protective devices, a transfer from the protection state into the connected state leads to a fixing of the two protective devices to each other, fixing by a positively locking connection of the first protective device to the second protective device using the first cover.

8. The connection system according to claim 1, wherein the first cover forms a locking region, which is configured to be brought into positively locking engagement with a complementary protrusion of the second cover of the second protective device for fixing the first protective device to the second protective device.

9. The connection system according to claim 1, wherein the coupling mechanism comprises a pin on the first protective cover or the second protective cover and a pin receptacle on the other protective cover, wherein the pin is configured to be latched into the pin receptacle.

10. The connection system according to claim 4, wherein the coupling mechanism comprises one or more webs on the first protective cover or the second protective cover and one or more recesses on the other protective cover, wherein the webs are configured to be brought into engagement in the recesses.

11. The connection system according to claim 1, wherein at least one of: the first cover and the second cover comprise one or more latches for defining at least one of: the protection state and the connected state.

12. The connection system according to claim 1, wherein at least one of: the first conductor is designed as a busbar or conductor rail; and the second conductor is designed as a terminal of a high-voltage battery.
